(19) United States
(12) Patent Application Publication
(10) Pub. No.: US 2014/0352374 A1
(43) Pub. Date: Dec. 4, 2014

(54) LOCK CYLINDER HAVING ENHANCED BURGLARPROOF EFFECT

(71) Applicant: Li Szu SHEN, Tainan City (TW)

(72) Inventor: Li Szu SHEN, Tainan City (TW)

(21) Appl. No.: 14/463,198

(22) Filed: Aug. 19, 2014

Related U.S. Application Data
(63) Continuation-in-part of application No. 13/855,851, filed on Apr. 3, 2013.

(51) Int. Cl. E05B 27/00

(52) U.S. Cl. CPC E05B 27/0057
USPC 70/357

(57) ABSTRACT

A lock cylinder includes a housing including an axial bore extending from a front end thereof through a rear end thereof along an axis. The axial bore includes a first larger section in the front end, a second larger section in the rear end, and a smaller section intermediate the first and second larger sections. An annular protrusion is integrally formed on an inner wall of the axial bore intermediate the first and second larger sections, and the smaller section is defined in the annular protrusion. The lock cylinder further includes first and second key plugs rotatably and respectively received in the first and second larger sections about the axis. Each of the first and second key plugs includes a keyway for insertion of a corresponding key. The keyways of the first and second key plugs and the smaller section of the axial bore are aligned with each other.

### CROSS REFERENCE TO RELATED APPLICATION

This is a continuation-in-part application of U.S. patent application Ser. No. 13/855,851 filed Apr. 3, 2013.

### BACKGROUND OF THE INVENTION

The present invention relates to a lock cylinder and, more particularly, to a lock cylinder which promotes a burglarproof effect.

A type of conventional anti-theft lock cylinder for locks generally includes an outer housing and an inner key plug rotatably received in the outer housing about an axis and having a keyway centrally extending along the axis. The outer housing and the key plug are internally provided with a plurality of tumbler pins for locking the key plug in the outer housing, thereby preventing unauthorized operation of the lock cylinder. When a special or corresponding key is inserted into the keyway of the key plug, the tumbler pins are lifted to a shear line between the outer housing and the key plug, allowing the key plug to be rotated relative to the outer housing to unlock the lock cylinder.

The lock cylinder mounted inside a lock is a sophisticated precise device with a critical function to prevent the lock from being easily and quickly unlocked by a burglar. One burglar or habitual thief, however, is still capable of easily unlocking the lock with a picking tool because the lock cylinder based on the prior art is equipped with a single key plug having a flat or cross keyway and, thus, is easily unlocked by the burglar who gradually inserts the picking tool into the keyway of the key plug. Specifically, those internal components of the lock cylinder are symmetrically arranged therein and will not be changed in their relative positions despite a turning action of the key plug relative to the outer housing in the process of inserting the picking tool into the keyway, failing to hinder the picking tool's constant probing to unlock the lock cylinder.

U.S. Pat. No. 3,500,670 discloses a lock mechanism including a cylinder bored longitudinally for reception in tandem arrangement of three key slotted plugs. Each of the plugs has one or more vertical bores which align with vertical bores in the cylinder to accommodate pin tumblers, drivers and springs for locking each plug against rotation relatively to the cylinder. The lock mechanism including three key slotted plugs in the cylinder is designed to prevent a burglar from utilizing an illegal picking tool to unlock the lock mechanism. However, since the three key slotted plugs in the cylinder are designed to be rotated, a burglar's picking tool can be utilized and inserted into the key slots of the three key slotted plugs and then slightly rotated about 3-5 degrees to withstand the tumbler pins, so that the tumbler pins can not return into its original holes, allowing the three key slotted plugs to be unlocked successively by the picking tool's. Moreover, since the three key slotted plugs in the cylinder are designed to be rotated, a force entry tool (such as a wrench) can be utilized to force open the lock mechanism with a bit of the tool inserted into the key slots of the three key slotted plugs and then forcibly rotated to destroy the tumbler pins, allowing the three key slotted plugs to be unlocked successively by the tool. Furthermore, the lock mechanism has a complex structure. Further, in assembly of the lock mechanism, precisely aligning the key slots of the three plugs in the cylinder along a longitudinal axis of the cylinder is not always easy, for the key slot of each plug has a non-circular cross section.

### BRIEF SUMMARY OF THE INVENTION

Therefore, an objective of the present invention is to provide a lock cylinder to improve the aforementioned shortcoming and deficiency of the prior art. The lock cylinder of the present invention is adapted to be utilized with locks for effectively preventing any burglar from utilizing an illegal picking tool or a force entry tool to unlock the lock cylinder, realizing better burglarproof effect of the locks. Further, the lock cylinder of the present invention is much simpler in construction than aforementioned, conventional lock cylinder with a plurality of plugs.

To achieve this and other objectives, a lock cylinder of the present invention includes a housing adapted to be mounted to a lock and including front and rear ends spaced along an axis. The housing further includes an axial bore extending from the front end through the rear end along the axis. The axial bore includes a first larger section in the front end, a second larger section in the rear end, and a smaller section intermediate the first and second larger sections along the axis. An annular protrusion is one-piece formed on an inner wall of the axial bore intermediate the first and second larger sections, and the smaller section of the axial bore is defined in the annular protrusion. The lock cylinder further includes at least two key plugs rotatably received in the first and second larger sections of the axial bore of the housing about the axis. Each of the at least two key plugs includes a keyway extending along the axis, and the keyways of the at least two key plugs allow insertion of a corresponding key for synchronously rotating the at least two key plugs. The smaller section of the axial bore is aligned with the keyways of the at least two key plugs along the axis. Thereby, the lock cylinder of the present invention can effectively prevent a force entry tool from turning the key plugs to provide an enhanced anti-theft effect.

Since the annular protrusion of the present invention is one-piece formed and can not be rotated relative to the housing, a force entry tool can be prevented from unlocking the lock cylinder of the present invention even if a bit of the force entry tool having a keyhole profile is inserted through the keyways of the key plugs and the smaller section of the axial bore. This is because the bit of the force entry tool inserted into the smaller section formed in the annular protrusion can not be forcibly rotated relative to the housing during unlocking process, but the bit will be broken (the strength of the bit is not sufficient to destroy the annular protrusion) and, thus, can not be forced to unlocking the lock cylinder of the present invention.

In a preferred form, each of the first and second larger sections of the axial bore has circular cross sections perpendicular to the axis. The at least two key plugs includes a first key plug rotatably received in the first larger section of the axial bore of the housing about the axis, and the keyway of the first key plug has a first key passage with cruciform cross sections perpendicular to the axis. The at least two key plugs further includes a second key plug rotatably received in the second larger section of the axial bore of the housing about the axis, and the keyway of the second key plug has a second key passage with cruciform cross sections aligned with the cruciform cross sections of the first key passage of the first key plug. The smaller section of the axial bore has cruciform cross sections aligned with the cruciform cross sections of the first key passage of the first key plug.

In another preferred form, the at least two key plugs includes a first key plug rotatably received in the first larger section of the axial bore of the housing about the axis, and the keyway of the first key plug has a first key passage with S-shaped cross sections perpendicular to the axis. The at least two key plugs further includes a second key plug rotatably received in the second larger section of the axial bore of the housing about the axis, and the keyway of the second key plug has a second key passage with S-shaped cross sections aligned with the S-shaped cross sections of the first key passage of the first key plug. The smaller section of the axial bore has S-shaped cross sections aligned with the S-shaped cross sections of the first key passage of the first key plug.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a lock cylinder according to a first embodiment of the present invention with a key constructed in accordance with a first embodiment inserted into the lock cylinder.

FIG. 2 shows a schematic view of the lock cylinder and the key of FIG. 1 with the key separated from the lock cylinder.

FIG. 3 shows an exploded, perspective view of the lock cylinder and the key of FIG. 1.

FIG. 4 shows a cross sectional view of the lock cylinder and the key of FIG. 1.

FIG. 5 shows another cross sectional view of the lock cylinder and the key of FIG. 1.

FIG. 6 shows a schematic top view of the lock cylinder of FIG. 2, illustrating a picking tool inserted into a first key plug of the lock cylinder.

FIG. 7 shows a perspective view of a lock cylinder according to a second embodiment of the present invention with a key constructed in accordance with a second embodiment inserted into the lock cylinder.

FIG. 8 shows an exploded, perspective view of the lock cylinder and the key of FIG. 7.

FIG. 9 shows a cross sectional view of the lock cylinder and the key of FIG. 7.

### DETAILED DESCRIPTION OF THE INVENTION

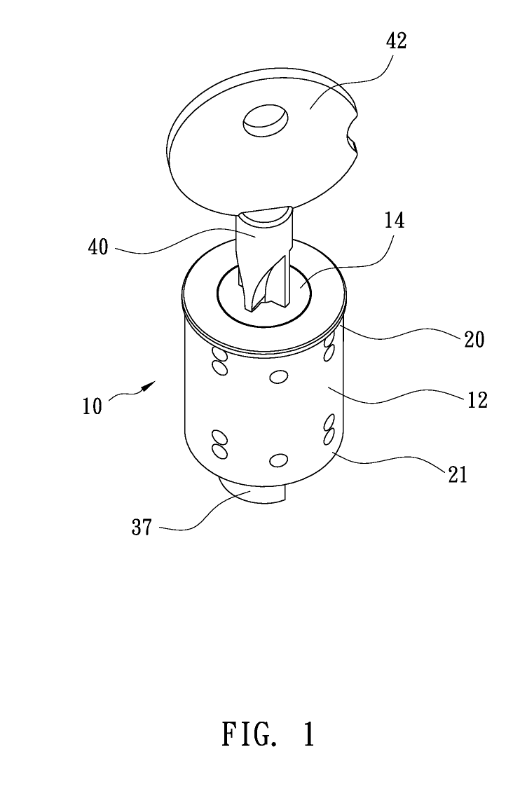

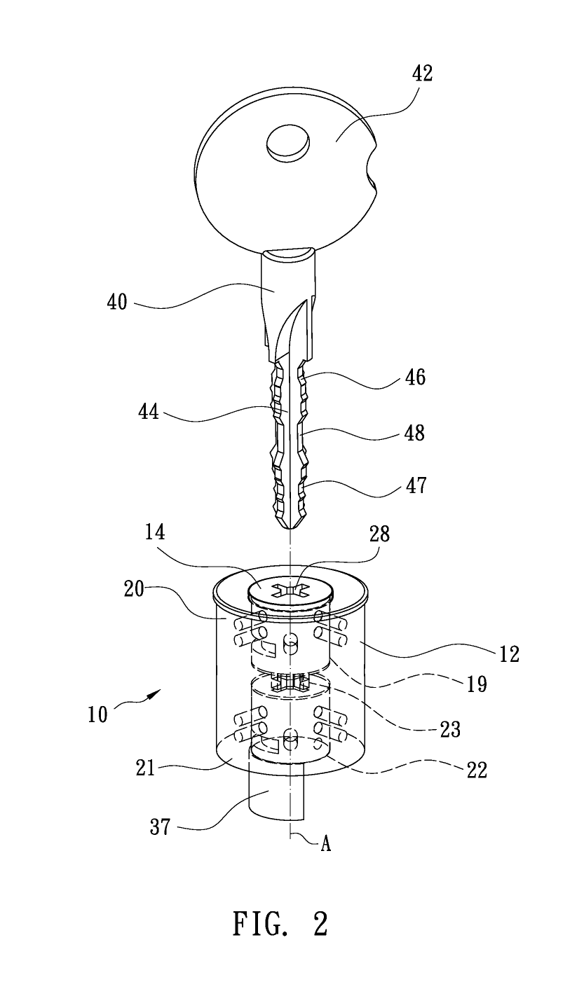

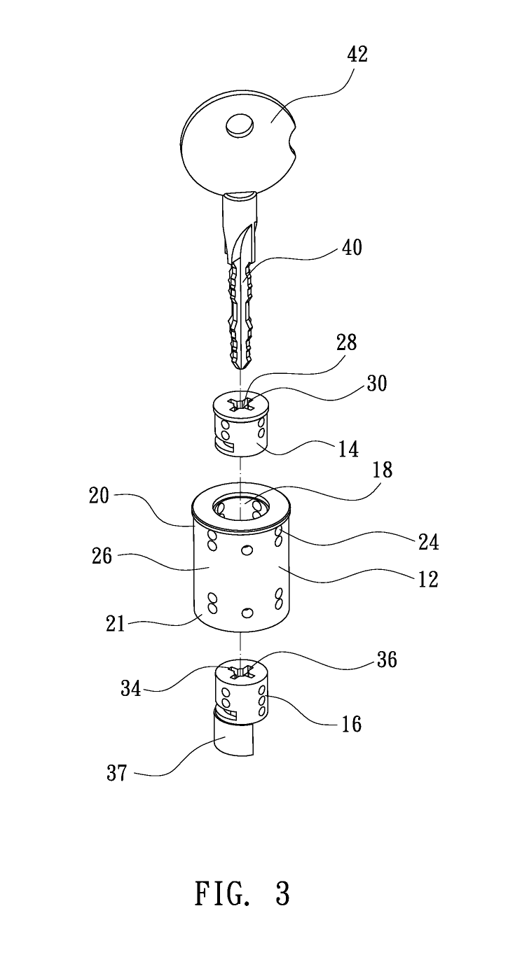

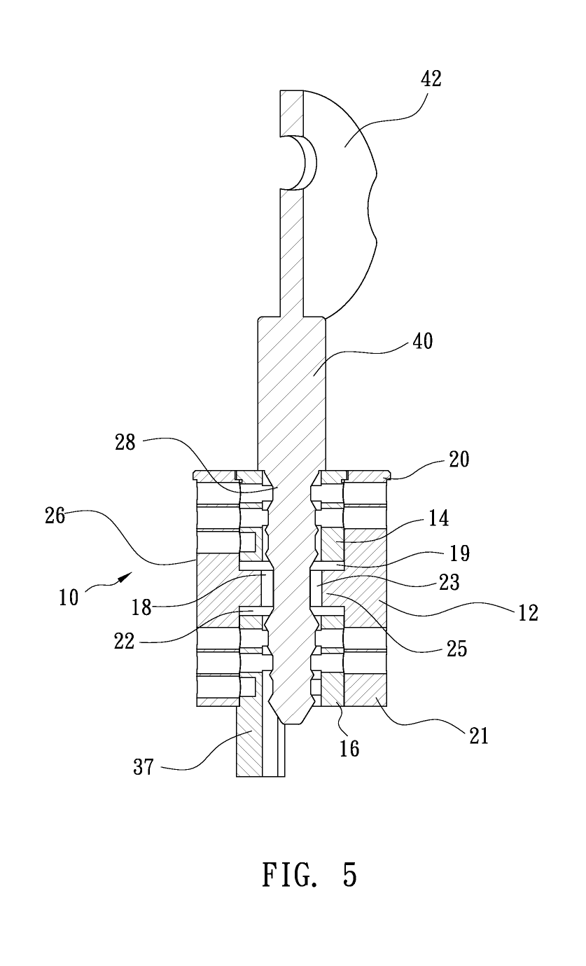

A lock cylinder of a first embodiment of the present invention is shown in FIGS. 1-6 of the drawings and generally designated 10. The lock cylinder 10 includes a cylinder or housing 12, and first and second key plugs 14 and 16. The lock cylinder 10 may be utilized with locks of any desired type including, but not limited to, gate locks, cylinder locks, steering wheel locks, shackle locks, motorcycle locks, bicycle locks, door locks, padlocks, car door locks, engine locks, and safe box locks.

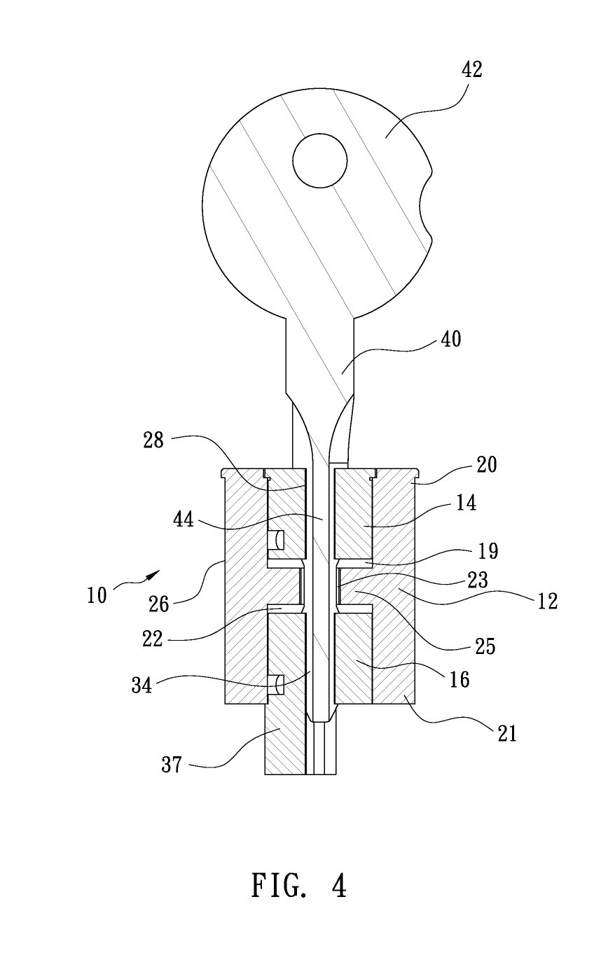

The housing 12 of the lock cylinder 10 is adapted to be mounted to a lock body of a lock and includes front and rear ends 20 and 21 spaced along an axis A. The housing 12 further includes an axial bore 18 extending from the front end 20 through the rear end 21 along the axis A. The axial bore 18 includes a first larger section 19 in the front end 20, a second larger section 22 in the rear end 21, and a smaller section 23 intermediate the first and second larger sections 19 and 22 along the axis A (see FIG. 4). In this embodiment, each of the first and second larger sections 19 and 22 of the axial bore 18 has circular cross sections perpendicular to the axis A, and the smaller section 23 of the axial bore 18 has cruciform cross sections smaller than the circular cross sections of each of the first and second larger sections 19 and 22. An annular protrusion 25 is one-piece formed on an inner wall of the axial bore 18 intermediate the first and second larger sections 19 and 22 along the axis A, and the smaller section 23 is defined in the annular protrusion 25. The housing 12 further includes a plurality of pin holes 24 each extending from an outer circumference 26 of the housing 12 to the axial bore 18.

The first key plug 14 is rotatably received in the first larger section 19 of the axial bore 18 of the housing 12 about the axis A. The first key plug 14 includes a first keyway 28 extending therethrough along the axis A and having a first key passage 30 with cruciform cross sections perpendicular to the axis A. The first key passage 30 is aligned with the smaller section 23 of the axial bore 18 along the axis A.

The second key plug 16 is rotatably received in the second larger section 22 of the axial bore 18 of the housing 12 about the axis and spaced from the first key plug 14 along the axis A. The second key plug 16 includes a second keyway 34 extending along the axis A and having a second key passage 36 with cruciform cross sections corresponding to that of the first key passage 30. The second key passage 36 is aligned with the first key passage 30 of the first key plug 14 along the axis A. Namely, the cross sectional contour of the second key passage 36 is aligned with that of the first key passage 30 along the axis A. An actuating portion 37 is formed on an outer end of the second key plug 16 for unlocking a bolt or similar member of the lock in which the lock cylinder 10 is mounted upon rotation of the second key plug 16.

It should be appreciated that the housing 12 and the first and second key plugs 14 and 16 are internally provided with a plurality of tumbler pins (not shown) and a plurality of springs (not shown) for biasing an end of each tumbler pin into one of the first and second keyways 28 and 34, thereby locking the first and second key plugs 14 and 16 in the front and rear ends 20 and 21 of the housing 12 respectively. Furthermore, the first and second key passages 30 and 36 allow insertion of a special or corresponding key 40 for synchronously rotating the first and second key plugs 14 and 16. In this embodiment, the key 40 includes a bow 42 for a user's grip and an elongated blade 44 having first and second code portions 46 and 47 spaced along a length thereof. Each of the first and second code portions 46 and 47 has cruciform cross sections. A reduced portion 48 is formed on an intermediate section between the first and second code portions 46 and 47 of the key 40. When the key 40 is inserted into the first and second keyways 28 and 34 of the first and second key plugs 14 and 16, the tumbler pins in the first and second key plugs 14 and 16 are respectively lifted by serrations or concavities of the first and second code portions 46 and 47, allowing the first and second key plugs 14 and 16 to be rotated together in the housing 12 under rotation of the key 40. Furthermore, the smaller section 23 of the axial bore 18 with cruciform cross sections allows the second code portion 47 of the key 40 to be extended through. In operation, when the key 40 is inserted into the first and second keyways 28 and 34 of the first and second key plugs 14 and 16, the reduced portion 48 of the key 40 is received in the smaller section 23 of the axial bore 18, allowing smooth rotation of the key 40 in the housing 12.

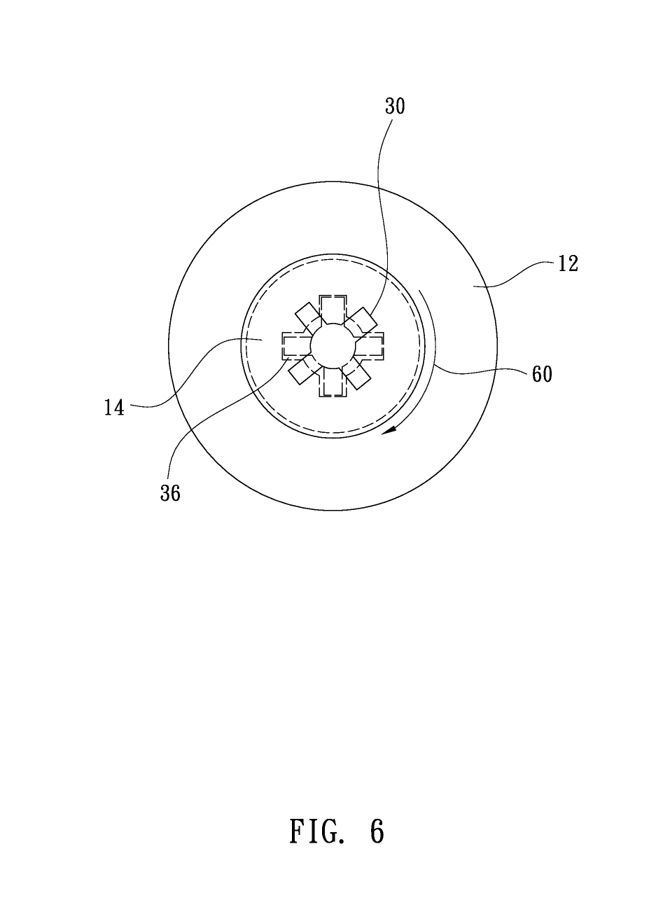

With the first and second key passages 30 and 36 of the first and second key plugs 14 and 16 aligned with the smaller section 23 of the axial bore 18, the lock cylinder 10 of the present invention can effectively avoid any burglar's illegal tool to be inserted into the second keyway 34 of the second key plug 16 for unlocking the lock cylinder 10. Specifically, the first key plug 14 will result in slight rotation relative to the second key plug 16 (see the arrow 60 in FIG. 6) when an illegal picking tool (not shown) is inserted into the first key passage 30 of the first key plug 14, so that the first key passage 30 of the first key plug 14 is rotated to a position non-aligned with the second key passage 36 of the second key plug 16. As such, the picking tool which has successfully passed through the first key passage 30 of the first key plug 14 cannot be inserted into the second key passage 36 of the second key plug 16 due to compressive deformation of the picking tool and/or misalignment of the first and second key passages 30 and 36. Furthermore, with the provision of the annular protrusion 25 integrally formed on an inner wall of the axial bore 18, force entry tools can also be prevented from unlocking the lock cylinder 10. Specifically, even if a bit of one force entry tool has passed through the first key passage 30 of the first key plug 14 and the smaller section 23 of the axial bore 18 and then into the second key passage 36 of the second key plug 16, the first and second key plugs 14 and 16 will be unable to be rotated in the housing 12 by the bit of the force entry tool, for the bit will be stuck in the annular protrusion 25 which is one-piece formed on the inner wall of the axial bore 18 of the housing 12 and can not be forcibly rotated by the force entry tool.

In addition, the annular protrusion 25 is of a one-piece construction with the housing 12, so that the lock cylinder 10 according to the present invention is easier and less expensive to manufacture and assemble relative to known lock cylinders with three key slotted plugs. Furthermore, the lock cylinder 10 according to the preferred teachings of the present invention includes only two key plugs 14 and 16, so that the time required for assembling the lock cylinder 10 is saved, and the assembly accuracy and quality are improved to provide reliable functions during operation.

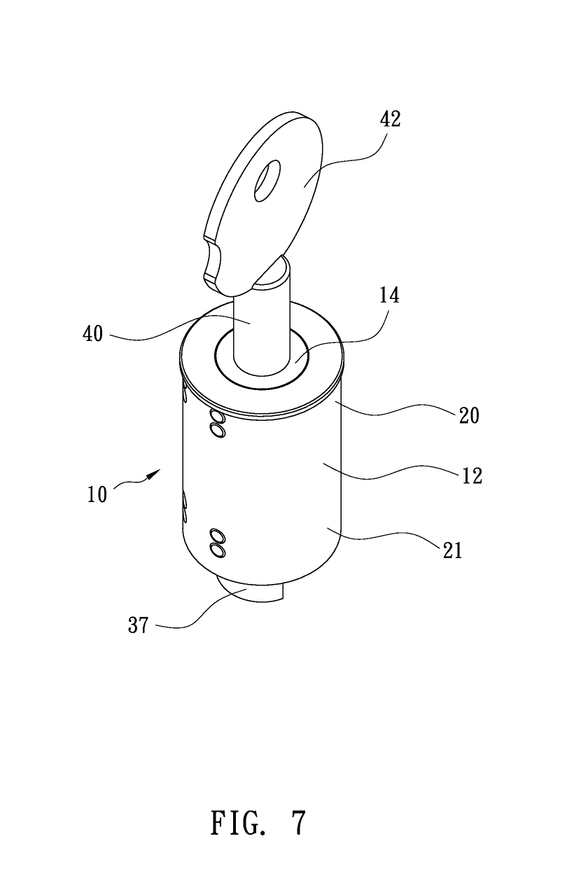

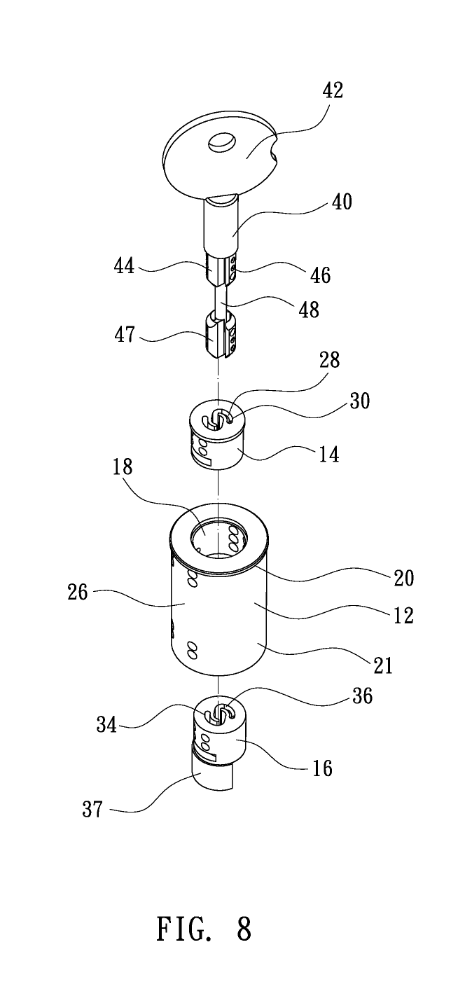

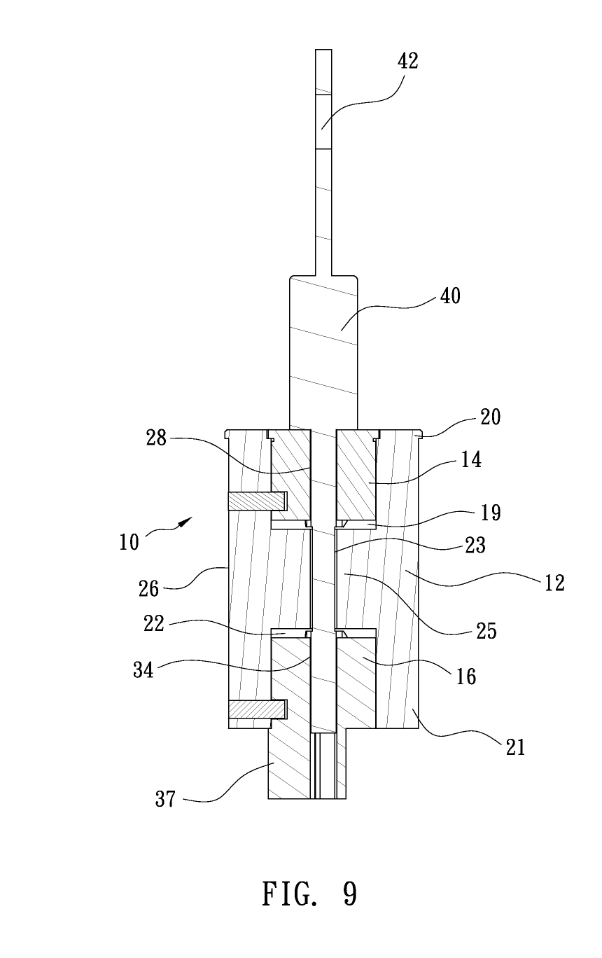

FIGS. 7-9 of the drawings show a second embodiment of the lock cylinder 10 according to the present invention. Description of the parts of the lock cylinder 10 shown in FIGS. 7-9 identical to those shown in FIGS. 1-6 is omitted. In particular, each of the first and second key passages 30 and 36 has S-shaped cross sections perpendicular to the axis A, and the first and second code portions 46 and 47 of the blade 44 of the key 40 respectively have S-shaped cross sections corresponding to those of the first and second key passages 30 and 36 of the first and second key plugs 14 and 16. Furthermore, the smaller section 23 of the axial bore 18 also has S-shaped cross sections corresponding to that of the second key passage 36 to allow second code portions 47 of the key 40 to be extended through. In this embodiment, the annular protrusion 25 has a length along the axis A greater than that of each of the first and second larger sections 19 and 22 along the axis A. Namely, thickness of the annular protrusion 25 can be increased according to the actual needs so as to strengthen the lock cylinder 10.

It is to be understood that the lock cylinder 10 of the present invention is not limited to the specific embodiments described and/or shown herein, and that the lock cylinder 10 according to the present invention can includes more than two key plugs having keyways aligned with one another. The contours of the first and second key passages 30 and 36 and the smaller section 23 of the axial bore 18 can be other geometric shapes in cross section.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims.

1. A lock cylinder having an enhanced burglarproof effect comprising:
a housing adapted to be mounted to a lock and including front and rear ends spaced along an axis, with the housing further including an axial bore extending from the front end through the rear end along the axis, with the axial bore including a first larger section in the front end, a second larger section in the rear end, and a smaller section intermediate the first and second larger sections along the axis, with an annular protrusion being one-piece formed on an inner wall of the axial bore intermediate the first and second larger sections, with the smaller section of the axial bore defined in the annular protrusion.

2. The lock cylinder as claimed in claim 1, wherein each of the first and second larger sections of the axial bore has circular cross sections perpendicular to the axis, with the at least two key plugs including a first key plug rotatably received in the first larger section of the axial bore of the housing about the axis, with the at least two key plugs further including a second key plug rotatably received in the second larger section of the axial bore of the housing about the axis.

3. The lock cylinder as claimed in claim 2, wherein the keyway of the first key plug has a first key passage with cruciform cross sections perpendicular to the axis, with the keyway of the second key plug having a second key passage with cruciform cross sections aligned with the cruciform cross sections of the first key passage of the first key plug, with the smaller section of the axial bore having cruciform cross sections aligned with the cruciform cross sections of the first key passage of the first key plug.

4. The lock cylinder as claimed in claim 2, wherein the keyway of the first key plug has a first key passage with S-shaped cross sections perpendicular to the axis, with the keyway of the second key plug having a second key passage with S-shaped cross sections aligned with the S-shaped cross sections of the first key passage of the first key plug, with the smaller section of the axial bore having S-shaped cross sections aligned with the S-shaped cross sections of the first key passage of the first key plug.

5. The lock cylinder as claimed in claim 1, wherein said lock cylinder further comprising at least two key plugs rotatably received in the first and second larger sections of the axial bore of the housing about the axis and axially spaced in the housing, with each of the at least two key plugs including a keyway extending along the axis, with the keyways of the at least two key plugs allowing insertion of a corresponding key for synchronously rotating the first and second key plugs, with the smaller section of the axial bore aligned with the keyways of the at least two key plugs along the axis.
